(19) United States
(12) Patent Application Publication
(10) Pub. No.: US 2008/0027901 A1
(43) Pub. Date: Jan. 31, 2008

(54) Systems and methods for database processing and management

(76) Inventor: Ronald Sanborn, South Windsor, CT (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,235

(22) Filed: Jul. 25, 2006

(51) Int. Cl. G06F 17/30

(52) U.S. Cl. 707/2

(57) ABSTRACT

Systems and methods are disclosed that include a processing component configured to access a database and execute statements in a document. The document includes a tag identifying whether database processing statements in the document are to be executed, and a tag identifying a group of the database processing statements.

### BACKGROUND

Database administrators and programmers typically use the Structured Query Language (SQL) to define executable statements and queries that provide the ability to modify or retrieve data from a database server. SQL offers a flexible language for manipulating databases of all shapes and sizes. Despite a number of commercially available graphical front end interface tools that allow a user to manipulate database records, many database administrators and developers rely upon custom-written SQL code to ensure that their transactions meet user requirements in the most efficient manner possible.

SQL includes features that allow an operator to accept changes and “commit” them to the database. Alternatively, an operator may reject the changes and “rollback” the database to a previous version or state. The rollback feature may also be invoked if an error condition occurs while processing SQL statements.

Custom SQL solutions require a great deal of time and energy to handle the routine aspects of developing SQL database processing. For example, custom SQL code generally requires not only coding SQL statements, but also developing exception handling, error logging, transactions, prior state restore/rollback capability, and state commit features using traditional software development languages such as C, C++, .NET, Java or other languages. Additionally, more than one type of database may be used in an organization that requires unique commands or statements for database processing. Accordingly, code that is developed for one type of database may not be usable to perform the same functions on another type of database.

### SUMMARY

Systems and methods are disclosed that include a processing component configured to access a database and execute statements in a document. The document includes a tag identifying whether database processing statements in the document are to be executed, and a tag identifying a group of the database processing statements.

### BRIEF DESCRIPTION OF THE DRAWINGS

The accompanying drawings, which are incorporated in and form a part of this specification, illustrate embodiments of the invention and, together with the description, serve to explain its principles:

FIG. 1 shows an embodiment of a computer system including database management components and documents;

FIG. 2 shows a hierarchical diagram of an embodiment of a process for using components and documents of FIG. 1 for database processing and management;

FIG. 3 shows an embodiment of functions that can be accessed via a user interface to generate database management documents of FIG. 1;

FIG. 4 shows an embodiment of a form generated by a user interface function to create a new data connection;

FIG. 5 shows an embodiment of a form generated by a user interface function to configure a new SQLML task;

FIG. 6 shows an embodiment of a form generated by a user interface function to modify a SQLML task;

FIG. 7 shows an embodiment of a form generated by a user interface function to schedule a SQLML task;

FIG. 8 shows an embodiment of a form generated by a user interface function to copy SQLML documents to an import directory;

FIG. 9 shows an embodiment of a form generated by a user interface function to delete SQLML documents from an import directory;

FIG. 10 shows an embodiment of a form generated by a user interface function to edit an SQLML document;

FIG. 11 shows an embodiment of a form generated by a user interface function to create a new SQLMLJOB document;

FIG. 12 shows an embodiment of a form generated by a user interface function to edit a SQLMLJOB document;

FIG. 13 shows an embodiment of a form generated by a user interface function to activate or deactivate a SQLMLJOB document; and

FIG. 14 shows an embodiment of a form generated by a user interface function to view contents of an import directory.

### DETAILED DESCRIPTION OF THE DRAWINGS

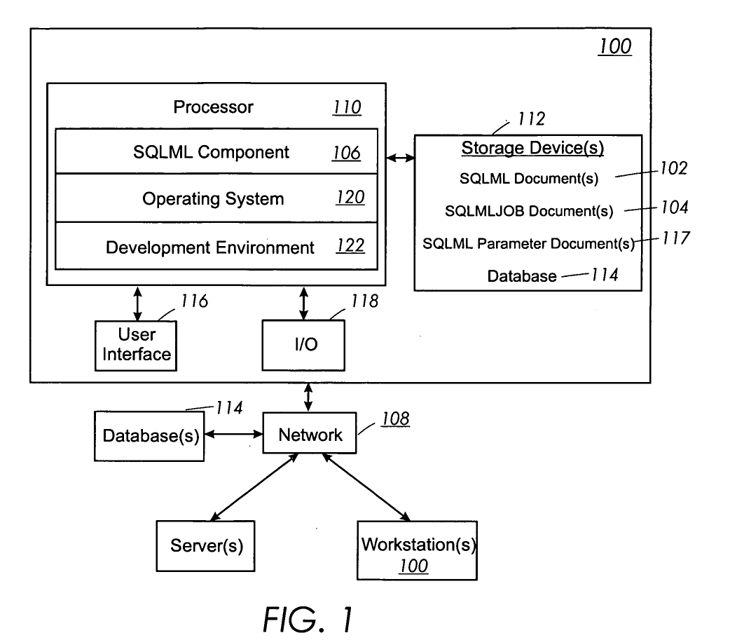

Systems and methods are disclosed that allow database processing to be defined within a text based Structured Query Language Markup Language (SQLML) or SQLMLJOB document using a standard text editor. Referring to FIG. 1, an embodiment of a computer workstation system 100 is shown in which SQLML documents 102, SQLMLJOB documents 104, and a SQLML component 106 can be used to eliminate time consuming and error prone process of developing custom SQL code to handle database processing and administration, web development, and application program development. SQLML allows the software developer to focus on creating SQLML documents 102 and SQLMLJOB documents 104 that describe the SQL statements and transactions for an application without the need to include code to establish a database connection; handle exceptions or errors, transactions, database rollback, or database commit; manage the complexity of job processing; or manage database compatibility. System 100 allows a software developer to create SQL database processing solutions in a high-level markup language without the need to use lower level programming languages such as C, C++, .NET or Java. Instead the software developer can focus on developing SQLML documents with a standard text editor and let SQLML component 106 perform the desired database processing.

In some embodiments, SQLML document(s) 102 include a set of markup tags that define groups of dynamic or static SQL code to be processed by SQLML component 106. SQLML documents 102 can also include tags to describe the database compatibility and the document version number. SQLMLJOB documents 104 allow jobs to be created that specify one or more SQLML documents 102. SQLML component 106 utilizes a database connection provided by the calling process, provides support for exception handling, error logging, and transaction rollback and commit operations.

Embodiments disclosed herein may be implemented in a variety of computer system configurations such as servers and/or workstations. Any suitable computer systems can be used, such as personal computers, hand-held devices, multi-processor systems, microprocessor-based or programmable consumer electronics, network PCs, network adapters, minicomputers, mainframe computers and the like. Embodiments of the invention may also be practiced in distributed computing environments, where some or all of the tasks are performed by remote processing devices, such as server(s) and/or workstations that are linked through a communications network 108 such as the Internet or a local area network. In a distributed computing environment, program modules may be located in both local and remote data storage devices. Additionally, some embodiments may be implemented as logic instructions and distributed on computer readable media or via electronic signals.

Note that although examples and embodiments disclosed herein are provided according to XML and SQL standards, it is anticipated that other suitable programming languages and/or dialects of the XML and SQL can be used to implement the claimed features. Further, one or more instances of SQLML component 106, SQLML document 102, SQLMLJOB document 104, and parameter document 117 can be created as needed.

Computer system 100 can include any number of processors 110 configured to communicate with one or more storage devices 112 such as a random access memory (RAM), read only memory (ROM), a CD-ROM, and/or magnetic disk drive. Local and/or remote storage devices 112 can be used to store files such as SQLML documents 102 and SQLMLJOB documents 104, executable program files, and data files including data in one or more databases 114. Database(s) 114 can be local to system 100 and/or accessed remotely via network 108, and implemented using any suitable database structure such as SQL Server, Oracle, among other SQL database types.

Processor 110 can also communicate with user interface 116, which allows a user to enter data and commands, and view information. In some embodiments, user interface 116 accesses SQLML parameter file 117 via storage device 112. Parameter file 117 can store information that can be added/edited by a user via user interface 116 and/or other suitable file editing technique, and then transferred to one or more files associated with SQLML and SQLMLJOB documents 102, 104. For example, information in a parameter file 117 can be transferred to a Document Type Definition (.dtd) file that is associated with an XML file. The .dtd and XML files together comprise a SQLML document 102 or SQLMLJOB document 104. User interface 116 can be implemented as a browser based interface, generate other interactive user display formats, and/or employ other suitable user interface techniques.

Processor 110 and user interface 116 can be configured to use one or more input/output (I/O) devices 118 that may include, but are not limited to, devices such as video monitors, track balls, mice, keyboards, microphones, touch-sensitive displays, transducer card readers, magnetic or paper tape readers, tablets, styluses, voice or handwriting recognition systems, and/or other suitable types of devices. Processor 110 optionally may be coupled to a computer and/or telecommunications network 108, e.g., a local area network and/or a wide area network such as the Internet. With such a network connection, processor 110 can receive information from the network 108, or output information to the network 108 during processing. Such information, which can be represented as a sequence of instructions to be executed using processor 110, may be received from and output to the network 108, for example, in the form of a computer data signal embodied in a carrier wave.

The embodiment of processor 110 shown is configured to execute several logic modules including SQLML component 106, operating system 120, and an interactive development environment (IDE) 122. Operating system 120 can be the UNIX, LINUX, Windows, or other suitable operating system that is capable of supporting processor 110, interfacing with network 108, storage devices 112, user interface 116, and I/O devices 118, and executing logic modules, such as SQLML component 106, and interactive development environment (IDE) 122.

Examples of IDE's 122 that can be used in system 100 include the Java IDE, Visual Basic IDE, and the Visual C++ IDE, among others. IDE 122 can include software development tools such as a syntax-directed editor, graphical tools for program entry, and integrated support for compiling and running the program and relating compilation errors back to the source. An IDE 122 typically allows a developer to view and alter execution of a program at the level of statements and variables.

SQLML and SQLMLJOB documents 102, 104 are processed by SQLML component 106 that provides a configured database connection and configuration. Typically a software developer creates SQLML documents and/or SQLMLJOB documents 104 that describe their database processing needs in terms of SQL statements. Exception handling and database transactions are described using the SQLML markup language. The software developer then designates the database compatibility for the document and the version and creates a parameter file to support dynamic SQL if necessary.

Once a SQLML document 102 and optionally a SQLMLJOB document 104 have been created they can be copied to a file system directory for processing by SQLML component 106. SQLML component 106 utilizes a database connection provided by the calling process, and provides statement processing, exception handling, error logging, transaction rollback and commit operations. If an error occurs the appropriate action is taken to rollback any changes that were made, if necessary, and an error is optionally logged. After successful processing, SQLML documents 102 and the optional SQLMLJOB documents 104 can be moved to an archive directory. If processing is not successful, SQLML documents 102 and the optional SQLMLJOB documents 104 can be moved to an error directory.

In some embodiments, SQLML document 102 or SQLMLJOB document 104 are written according to the Extensible Markup Language (XML) standards using tags specifically developed for SQLML and SQMLJOB documents 102, 104. A Document Object Model (DOM) is a programming interface for XML documents that defines the way a document can be accessed and manipulated. Using a DOM, a programmer can create a document, navigate its structure, and add, modify, or delete elements in the document. A DOM represents a tree view of an XML document. The documentElement is the top-level of the tree. The documentElement can have one or more childNodes that represent the branches of the tree. SQLML document 102 or SQLMLJOB document 104 can be implemented as Document Type Definition (.dtd) files, which define the building blocks of an XML document with a list of legal elements. A .dtd file can be declared inline in an XML document, or referenced externally.

Tables 1 and 2 below show examples of tags that can be included in SQLML documents 102 and SQLMLJOB documents 104, respectively.

TABLE 1
SQLML Document Tags

| | |
|---|---|
| <sqlml> | Main document tag |
| <sqlmlversion> | sqlml version tag |
| <sqlmlhelp> | Identifies the help text for a SQLML document 102 |
| <compatibility> | Describes the databases with which the SQL statements in |
| | the document are compatible. |
| <parameters> | Identifies a grouping of parameter tags. Each parameters tag |
| | may include zero or more parameter tags. |
| <parameter> | Includes a paramname, paramvalue and a paramhelp tag. |
| <paramname> | Identifies the parameter name that maps to an entity name |
| | that will be generated in the corresponding file when the |
| | SQLML component 106 executes a SQLML document 102. |
| | In some embodiments, a Document Type Definition (.dtd file) is used. |
| <paramvalue> | Identifies the parameter value that maps to an entity name |
| | that will be generated in a corresponding file when the |
| | SQLML component 106 processes a SQLML document 102. |
| <paramhelp> | Identifies the help text for the parameter. |
| <node> | Identifies a grouping of tags node tags may have node tags |
| | within each node. <node> tags may encapsulate one or more |
| | <transaction> tags. |
| <name> | Identifies the name of the current node. In some |
| | embodiments, <name> is the first tag within a node and there |
| | is only one <name> tag per node. |
| <exec> | Specifies whether the SQL statements in current node will be |
| | executed. For example, |
| | <exec>1</exec> specifies “Yes” |
| | <exec>0</exec> specifies “No” |
| | In some embodiments, <exec> is the second tag within a |
| | node and there is only one <exec> tag per node. |
| <transaction> | Identifies a group of SQL statements that will execute within a |
| | transaction. If any of the SQL statements fail the transaction |
| | can be rolled back and the SQLML file can be moved to an |
| | Errors directory. <transaction> tags may include one or more |
| | <sql> tags. |
| <catch> | Allows errors to be caught and logged by SQLML component |
| | 106. A SQLML document 102, 104 can be moved to an Errors |
| | directory when an error occurs during processing. |
| <sql> | Defines SQL statements, commands and/or stored |
| | procedures that will be executed by SQLML component 106. |
| | In some embodiments, <sql> tags that are not inside of a |
| | <catch> tag will not halt processing if an error occurs. The |
| | error will only be logged. Also, <sql> tags that are not |
| | between <transaction> tags will typically not be rolled back if |
| | an error occurs. |

TABLE 2
SQLMLJOB Document Tags

| | |
|---|---|
| <sqlmljob> | Main document tag. |
| <sqlmlversion> | Sqlml version tag. |
| <sqlmlhelp> | Identifies the help text for the sqlml document. |
| <compatibility> | Identifies databases with which the job is compatible. |
| <job> | Specifies document tags that describe the SQLML documents that are |
| | to be executed within the job. |
| <transaction> | Identifies a group of SQL statements that will execute within a |
| | transaction. If any of the SQL statements fail the transaction |
| | can be rolled back and the SQLML file can be moved to an Errors |
| | directory. <transaction> tags may include one or more <document> |
| | tags. |
| <catch> | Allows errors to be caught and logged by SQLML component |
| | 106. A SQLMLJOB document 102, 104 can be moved to an |
| | Errors directory when an error occurs during processing. |
| <document> | Identifies a SQLML document 102 to be processed within the job. |

An example Document Type Definition (.dtd) file for an SQLML document 102 (sqlml.dtd) is as follows:

=====================================================
Sample sqlml.dtd
=====================================================
<!ELEMENT sqlml (sqlmlversion, sqlmlhelp, compatibility, node+)>
<!ELEMENT sqlmlversion (#PCDATA)>
<!ELEMENT sqlmlhelp (#PCDATA)>
<!ELEMENT compatibility (database*)>
<!ELEMENT database (#PCDATA)>
<!ELEMENT node (name, exec, sql*, transaction*, catch*, sql*, node*)>
<!ELEMENT transaction (catch*)>
<!ELEMENT name (#PCDATA)>
<!ELEMENT exec (#PCDATA)>
<!ELEMENT catch (sql*)>
<!ELEMENT sql (#PCDATA)>

### Note that ELEMENTS of the .dtd file can specify one or more parameters

An example .dtd file for an SQLMLJOB document 104 (sqlmljob.dtd) is as follows:

======================================================
Sample sqlmljob.dtd
======================================================
<!ELEMENT sqlmljob (sqlmlversion, sqlmlhelp, compatibility, job)>
<!ELEMENT sqlmlversion (#PCDATA)>
<!ELEMENT sqlmlhelp (#PCDATA)>
<!ELEMENT compatibility (database*)>
<!ELEMENT database (#PCDATA)>
<!ELEMENT job (transaction*, document*)>
<!ELEMENT transaction (catch*)>
<!ELEMENT catch (document*)>
<!ELEMENT document (#PCDATA)>

### Note that the XML .dtd documents can be extended to include other elements in addition to or instead of the sample elements shown.

An embodiment of the SQLML document 104 entitled “rum_xdb_purge_user.xml” specified in the example SQLMLJOB document 104 above is as follows:

```
======================================================
Sample: rum_xdb_purge_user.xml
======================================================
<?xml version=“1.0” ?>
<!DOCTYPE sqlml SYSTEM “rum_xdb_purge_user.dtd”>
<sqlml>
    <sqlmlversion>1.0</sqlmlversion>
    <sqlmlhelp>This SQLML Document is designed to purge a
    Computer and User and associated Usage Data</sqlmlhelp>
    <compatibility>
        <database>SQL Server</database>
        <database>Oracle</database>
    </compatibility>
<node>
    <name>Oracle Purge User</name>
    <exec>&Exec.1;</exec>
<transaction>
    <catch>
        <sql>
        DELETE rcaWindowsConcurrentUsage
        WHERE WindowsComputerUser_id IN
        (SELECT WindowsComputerUser_id FROM
        rcaWindowsComputerUsers WHERE ComputerName =
        ‘&Computer;’ AND UserName = ‘&User;’)
        </sql>
        <sql>
        DELETE rcaWindowsComputerUsers
        WHERE WindowsComputerUser_id IN
        (SELECT WindowsComputerUser_id FROM
        rcaWindowsComputerUsers WHERE ComputerName =
        ‘&Computer;’ AND UserName = ‘&User;’)
        </sql>
    </catch>
</transaction>
</node>
</sqlml>
```

An embodiment of a dtd file for the SQLML document 104 entitled “rum_xdb_purge_user.dtd” specified in the example rum_xdb_purge_user.xml file above is as follows:

======================================================
Sample: rum_xdb_purge_user.dtd
======================================================
<!ELEMENT sqlml (sqlmlversion, sqlmlhelp, compatibility, node+)>
<!ELEMENT sqlmlversion (#PCDATA)>
<!ELEMENT sqlmlhelp (#PCDATA)>
<!ELEMENT compatibility (database*)>
<!ELEMENT database (#PCDATA)>
<!ELEMENT node (name, exec, sql*, transaction*, catch*, sql*, node*)>
<!ELEMENT transaction (catch*)>
<!ELEMENT name (#PCDATA)>
<!ELEMENT exec (#PCDATA)>
<!ELEMENT select (#PCDATA)>
<!ELEMENT process (#PCDATA)>
<!ELEMENT catch (sql*)>
<!ELEMENT sql (#PCDATA)>
<!ENTITY Exec.1 “1”>
<!ENTITY Computer “MYCOMPUTER”>
<!ENTITY User “BOB”>

An embodiment of a SQLML parameter document 105 for the dtd file entitled “rum_xdb_purge_user.dtd” shown above is:

```
<?xml version=“1.0” ?>
<!DOCTYPE sqlmlparameters SYSTEM “sqlmlparameters.dtd”>
<sqlmlparameters>
    <sqlmlversion>1.0</sqlmlversion>
    <sqlmlhelp>This SQLML Document is designed to purge a
Computer and its associated Usage Data</sqlmlhelp>
    <parameters>
        <parameter>
            <paramname>Exec.1</paramname>
            <paramvalue>1</paramvalue>
            <paramhelp>Set Value equal to 1 to execute the
corresponding block of sql.</paramhelp>
        </parameter>
        <parameter>
            <paramname>Computer</paramname>
            <paramvalue>MYCOMPUTER</paramvalue>
            <paramhelp>This parameter specifies Computer that
will be purged along with it's associated Usage Data.</paramhelp>
        </parameter>
        <parameter>
            <paramname>User</paramname>
            <paramvalue>BOB</paramvalue>
            <paramhelp>This parameter specifies User that will
be purged along with it's associated Usage Data.</paramhelp>
        </parameter>
    </parameters>
</sqlmlparameters>
```

An embodiment of the SQLML document 104 entitled “rum_xdb_purge_computer.xml” specified in the example SQLMLJOB document 104 above is as follows:

```
======================================================
Sample: rum_xdb_purge_computer.xml
======================================================
<?xml version=“1.0” ?>
<!DOCTYPE sqlml SYSTEM “rum_xdb_purge_computer.dtd”>
<sqlml>
    <sqlmlversion>1.0</sqlmlversion>
    <sqlmlhelp>This SQLML Document is designed to purge a
    Computer and its associated Usage Data</sqlmlhelp>
    <compatibility>
        <database>SQL Server</database>
        <database>Oracle</database>
    </compatibility>
<node>
    <name>Oracle Purge Computer</name>
    <exec>&Exec.1;</exec>
    <transaction>
        <catch>
            <sql>
                DELETE rcaWindowsConcurrentUsage
                WHERE WindowsComputerUser_id IN
                (SELECT WindowsComputerUser_id FROM
                rcaWindowsComputerUsers WHERE
                ComputerName
                = ‘&Computer;’)
            </sql>
            <sql>
                DELETE rcaWindowsComputerUsers
                WHERE WindowsComputerUser_id IN
                (SELECT WindowsComputerUser_id FROM
                rcaWindowsComputerUsers WHERE
                ComputerName
                = ‘&Computer;’)
            </sql>
        </catch>
    </transaction>
</node>
</sqlml>
```

An embodiment of a .dtd file for the SQLML document 104 entitled “rum_xdb_purge_computer.dtd” specified in rum_xdb_purge_computer.xml file above is as follows:

======================================================
Sample: rum_xdb_purge_computer.dtd
======================================================
<!ELEMENT sqlml (sqlmlversion, sqlmlhelp, compatibility, node+)>
<!ELEMENT sqlmlversion (#PCDATA)>
<!ELEMENT sqlmlhelp (#PCDATA)>
<!ELEMENT compatibility (database*)>
<!ELEMENT database (#PCDATA)>
<!ELEMENT node (name, exec, sql*, transaction*, catch*, sql*, node*)>
<!ELEMENT transaction (catch*)>
<!ELEMENT name (#PCDATA)>
<!ELEMENT exec (#PCDATA)>
<!ELEMENT select (#PCDATA)>
<!ELEMENT process (#PCDATA)>
<!ELEMENT catch (sql*)>
<!ELEMENT sql (#PCDATA)>
<!ENTITY Exec.1 “1”>
<!ENTITY Computer “MYCOMPUTER”>

An embodiment of a SQLML parameter document 105 for the dtd file entitled “rum_xdb_purge_computer.dtd” shown above is:

```
<?xml version=“1.0”?>
<!DOCTYPE sqlmlparameters SYSTEM “sqlmlparameters.dtd”>
<sqlmlparameters>
    <sqlmlversion>1.0</sqlmlversion>
    <sqlmlhelp>This SQLML Document is designed to purge a
Computer and its associated Usage Data</sqlmlhelp>
    <parameters>
        <parameter>
            <paramname>Exec.1</paramname>
            <paramvalue>1 </paramvalue>
            <paramhelp>Set Value equal to 1 to execute the
corresponding block of sql.</paramhelp>
        </parameter>
        <parameter>
            <paramname>Computer</paramname>
            <paramvalue>MYCOMPUTER</paramvalue>
            <paramhelp>This parameter specifies the Computer
and associated Usage Data to be purged</paramhelp>
        </parameter>
    </parameters>
</sqlmlparameters>
```

Note that other suitable tags and elements can be included in SQLML and SQLMLJOB documents 102, 104 in addition to or instead of those provided in the examples herein. Note also that SQLML and SQLMLJOB documents 102, 104 and .dtd files may be uniquely named to provide instancing. SQLML and SQLMLJOB 102, 104 documents may be cloned and associated with a corresponding .dtd file to provide a queue of documents and jobs to be processed to support instancing of each unique job and document. SQLML parameter files may be instanced to provide programmatic access to the sum of the instance data present on a file system.

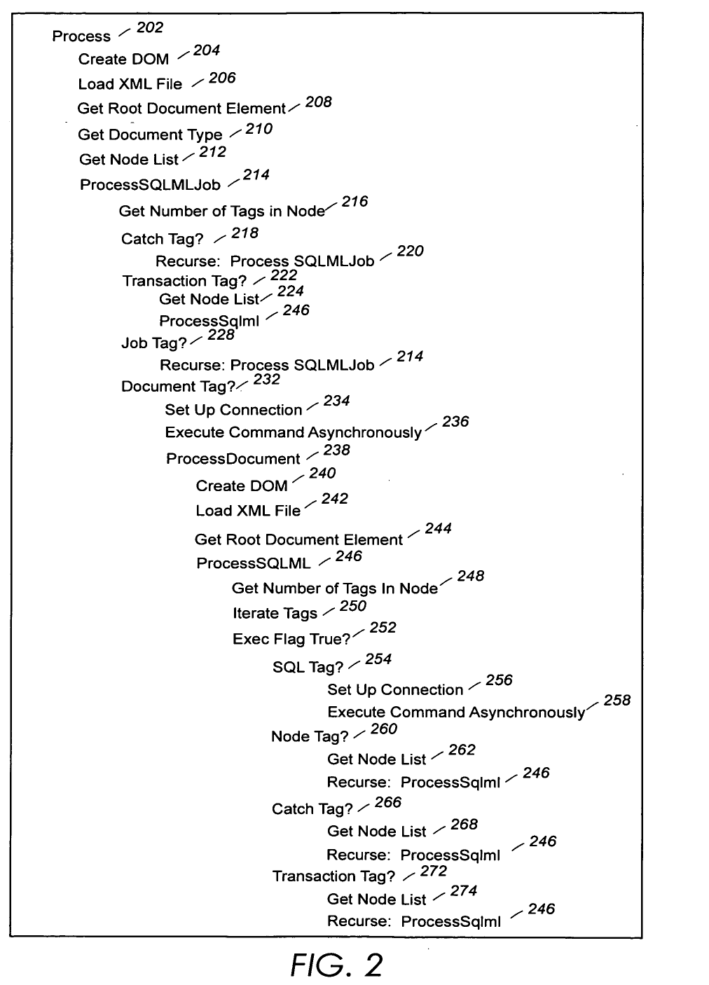

SQLML component 106 can be configured to parse SQLML documents 102 and SQLMLJOB documents 104 and perform various processes, such as shown by the hierarchy of processes 202-274 in FIG. 2. Processes 202-274 can be invoked via user interface 116 (FIG. 1), via another process within or external to SQLML component 106, and/or other suitable method. Suitable parameters can be provided to processes 202-274 via arguments when processes 202-274 are invoked, via a parameter file, or other suitable method. Such parameters can specify, for example, a database connection, a filename of SQLML document 102 or SQLMLJOB document 104 to be processed, nodes to be processed, whether any events such as errors should be logged, the name of a log file to be used, and level of detail to include in log information, among others. For example, in some embodiments, logic in SQLML component 106 can be invoked as follows:
Process(lUnknown *pConnection, BSTR Filename, long hEventCancel, BSTR LogFile, long LogLevel)
   where the parameters “lUnknown *pConnection” specifies a database connection, “BSTR Filename” specifies a filename of SQLML document 102 or SQLMLJOB document 104 to be processed, “long hEventCancel” specifies whether to wait until an Event Cancel is raised when an error occurs and/or identify an address to return to, “BSTR LogFile” specifies the name of a log file to be used for error messages, and “long LogLevel” is a value that specifies the level of detail desired for log information. Note that other suitable parameters can be used in addition to or instead of the above-mentioned parameters.

Process 202 is a top level function that includes logic for invoking other processes 204-214 as needed, as well as initializing variables including variables used to handle (catch) error conditions and log information about events and errors, among others. Process 202 can invoke process 204 to create a Document Object Model (DOM) based on a specified XML filename for an SQLML document 102 or SQLMLJOB document 104. Process 206 loads the XML file specified when the logic in SQLML component 106 is invoked. Process 208 gets the root document element from the XML file and process 210 gets the document type, for example, whether the XML file is a SQLML document 102 or a SQLMLJOB document 104.

SQLML and SQMLJOB documents 102, 104 can include tags that denote various types of information for database processing, as further described in Tables 1 and 2 herein. Process 212 determines the number of <node> tags in the XML document to provide a counter that can be used to iterate through each of the nodes to perform the functions represented by SQLML tags and SQL statements in SQLML and SQMLJOB documents 102, 104.

Process 214 is invoked for each node, which determines the number of tags in the node in process 216 and invokes one or more of processes 218-274, depending on the type of tag being processed. In some embodiments, process 214 can include incrementing or decrementing an index according to the number of SQLML tags detected between node tags.

Process 218 determines whether the next tag is a <catch> tag. The <catch> tag indicates that a log of information should be kept for errors and exceptions. When a <catch> tag is detected, process 220 recursively invokes process 214 to continue iterating through the tags.

SQLML component 106 can also include logic to handle errors and exceptions during processing. In some embodiments, <catch> tags are used in SQLML and SQMLJOB documents 102, 104 to indicate whether errors and exceptions that are raised during transaction processing should be logged. SQLML component 106 can also include logic to rollback any changes made that are not committed before an error or exception occurs. The error handling and rollback logic can be included in any one or more of processes 202-274.

Process 222 determines whether the next tag is a <transaction> tag. If so, process 224 generates a reference to a list of the <node> tags within the <transaction> tag. Process 226 invokes ProcessSQLML process 246, which iterates through and performs processes specified by the SQLML tags for each node, as further described herein.

Process 228 determines whether the next tag is a <job> tag. If so, ProcessSQLMLJob process 214 is invoked to iterate through and performs processes specified by the SQLML tags for each node, as further described herein.

Process 232 determines whether the next tag is a <document> tag. If so, the following processes are invoked:
process 234 utilizes a connection to the specified database 114 (FIG. 1);
process 236 establishes asynchronous handling of commands to allow errors and exceptions to be trapped when they occur during processing; and
ProcessDocument process 238 is invoked to iterate through the tags in the document.

ProcessDocument process 238 invokes the following processes:
process 240 creates the Document Object Model (DOM) for the document;
process 242 loads the XML file;
process 244 gets the root document element; and
ProcessSQLML process 246, which iterates through the document to perform the operations requested, as indicated by the SQLML tags in the document.

In some embodiments, ProcessSQLML process 246 invokes process 248 to get the number of tags between <node> and </node> tags. The number of tags can be used as an index for iterating through the tags in process 250. If the <exec> tags indicate that SQL statements will be executed, process 254 is invoked to determine whether the next tag is a <SQL> tag. If so, a connection to the database is utilized in process 256 and the SQL commands are executed, typically asynchronously, in process 258. If the current tag is not a <SQL> tag but is a <node> tag, as determined in process 260, process 262 gets a list of the nodes within the node tag and recursively invokes ProcessSqlml process 246 for each node. If the current tag is not a <SQL> tag or a <node> tag but is a <catch> tag, as determined in process 266, process 268 gets a list of the nodes and recursively invokes ProcessSqlml process 246 for each node. If the current tag is not a <SQL> tag, a <node> tag, or a <catch> tag but is a <transaction> tag, as determined in process 272, process 274 gets a list of the nodes and recursively invokes ProcessSqlml process 246 for each node.

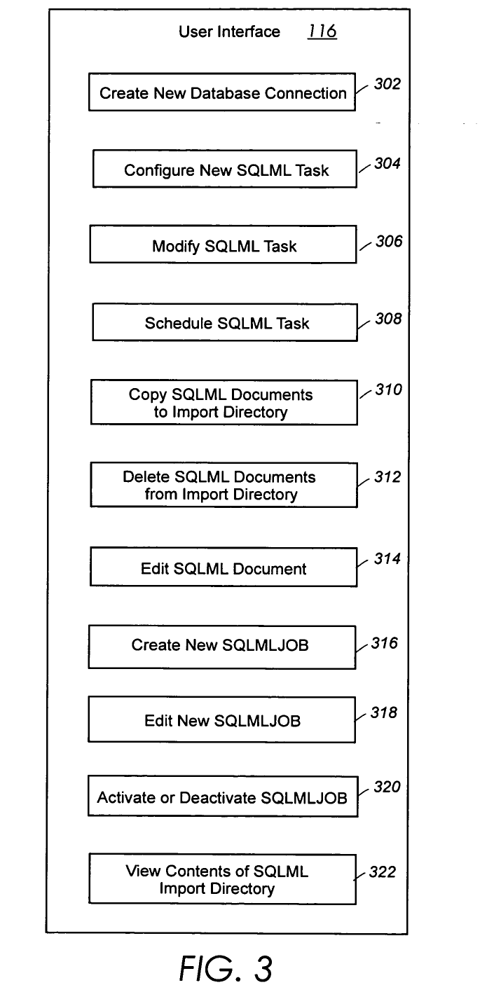

Referring now to FIG. 3, an embodiment of functions available from user interface 116 is shown. User interface 116 allows a database administrator or other user to access interactive processes to create, edit, delete, activate an deactivate SQLML documents 102, 104. The functions shown include create a new data connection 302, configure a new SQLML task 304, modify a SQLML task 306, schedule a SQLML task 308, copy SQLML documents to an import directory 310, delete SQLML documents from an import directory 312, edit an SQLML document 314, create a new SQLMLJOB document 316, edit a SQLMLJOB document 318, activate or deactivate a SQLMLJOB document 320, and view contents of an SQLML import directory 322.

Referring to FIGS. 3 and 4, an embodiment of a form 400 generated by process Create a New Data Connection 302 is shown that allows the user to enter a name for the database connection, indicate the name of the data source, and a user name and password that may be required to access the database 114 (FIG. 1). This information is used in process 202 (FIG. 2) to utilize a connection to the desired database 114. Form 400 can be configured to accept one or more database names, data sources, and/or username/passwords.

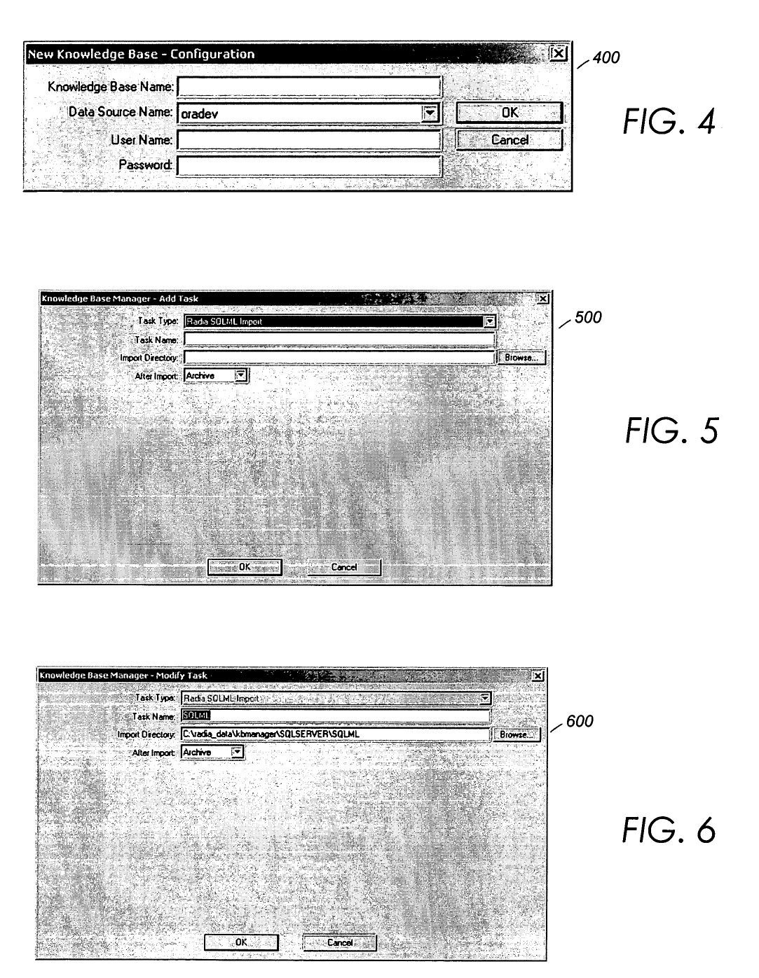

Referring to FIGS. 3 and 5, an embodiment of a form 500 generated by process Configure a new SQLML Task 304 is shown that allows the user to add a task by indicating a task type, a task name, an import directory where files associated with the task are located, and an option specifying whether the processed documents will be archived to an archive directory contained within the import directory, deleted from the import directory, or left in the import directory to be processed based on the selected schedule for the given task.

Referring to FIGS. 3 and 6, an embodiment of a form 600 generated by process Modify a SQLML Task 306 is shown that allows the user to modify a task by changing the task name, the import directory where files associated with the task are located, and/or whether the file will be archived, deleted, or left in the directory after the import-process has completed.

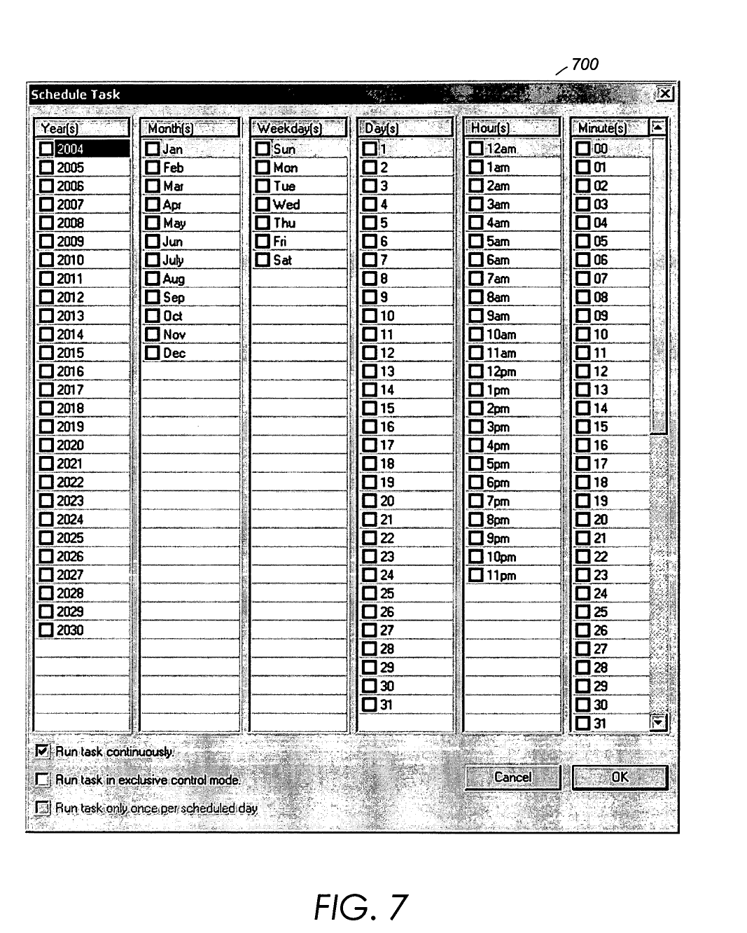

Referring to FIGS. 3 and 7, an embodiment of a form 700 generated by process Schedule a SQLML Task 308 is shown that allows the user to schedule a task by entering the year(s), month(s), days of the week, days of the month, hour(s), and/or minutes(s) that the task indicated in forms 500 or 600 should run. The user can also select options to run the task continuously, to run the task in exclusive control mode, or run the task only once per scheduled day.

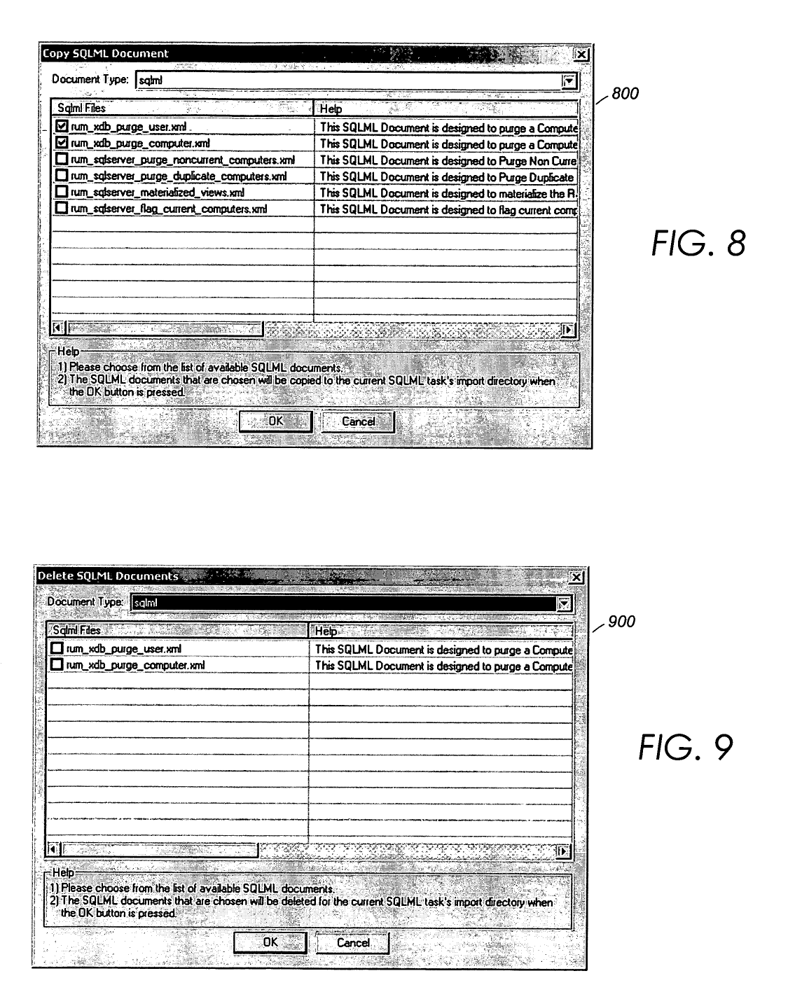

Referring to FIGS. 3 and 8, an embodiment of a form 800 generated by process Copy SQLML Documents to an Import Directory 310 is shown that allows the user to select from a list of available SQLML documents that will be included in the task. The documents selected from the list will be copied to the SQLML task's import directory when an option to accept the list of documents is selected.

Referring to FIGS. 3 and 9, an embodiment of a form 900 generated by process Delete SQLML Documents From an Import Directory 312 is shown that allows the user to select SQLML documents that will be deleted from the specified task's import directory when an option to delete the list of documents is selected.

Referring to FIGS. 3 and 10, an embodiment of a form 1000 generated by process Edit an SQLML Document 314 is shown that allows the user to edit parameters in SQLML documents. When a user selects a SQLML file, the associated parameters are displayed in form 1000. A user can select a parameter and enter a new value for the parameter in a data entry field in form 1000. An option to save the new value for the parameter can then be selected. Note that SQLML, SQLMLJOB, and SQLML parameter documents 102, 104, 117 can also be edited with a standard text editor as well.

SQLML, SQLMLJOB, and SQLML parameter documents 102, 104, 117 can be hosted by a Web Server (not shown) by utilizing state information stored on an external database server, file system, message queue or other software or device that provides data instancing. In this way the described documents may be defined as dynamic and rendered by the Web Server or other process.

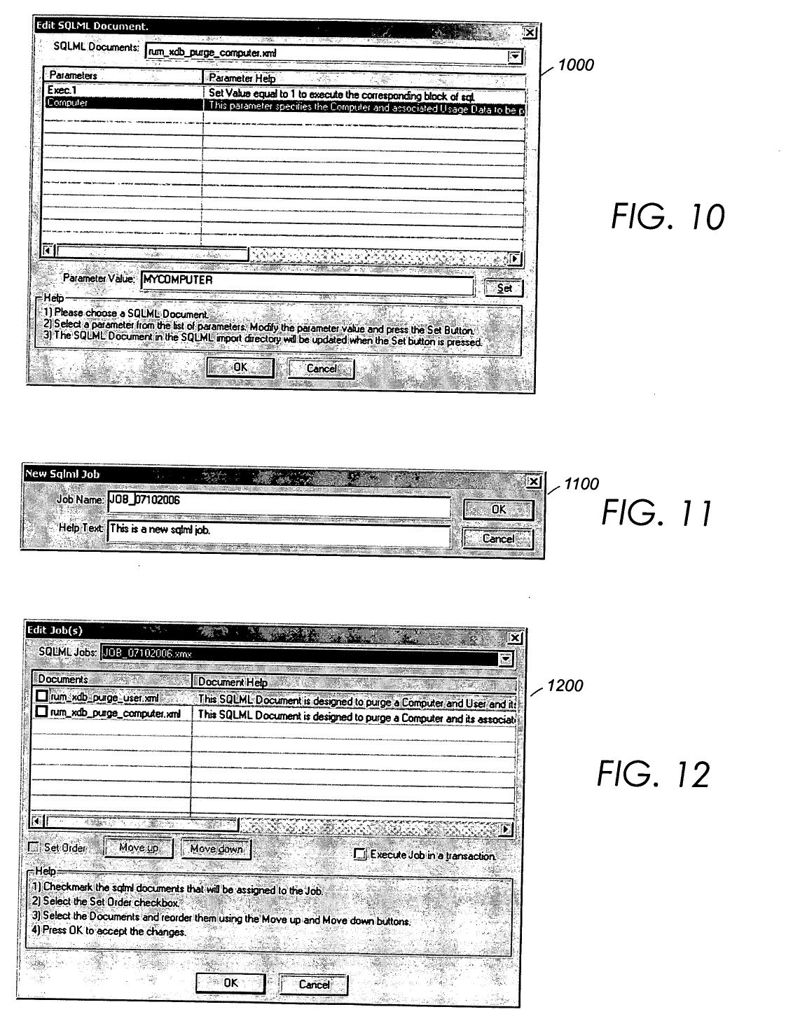

Referring to FIGS. 3 and 11, an embodiment of a form 1100 generated by process Create a New SQLMLJOB Document 316 is shown that allows the user to create a new SQLMLJOB document 104 (FIG. 1). Form 1100 can also allow the user to enter a comment or explanation of the functions performed by the task. This comment can be displayed along with the name of the document in other forms, such as copy SQLML document form 800 or delete SQLML document form 900.

Referring to FIGS. 3 and 12, an embodiment of a form 1200 generated by process Edit a SQLMLJOB Document 318 is shown that allows the user to edit a SQLMLJOB document 104. Form 1100 can also allow the user to enter a comment or explanation of the functions performed by the task. The comment can be displayed along with the name of the document in other forms, such as copy SQLML document form 800 or delete SQLML document form 900.

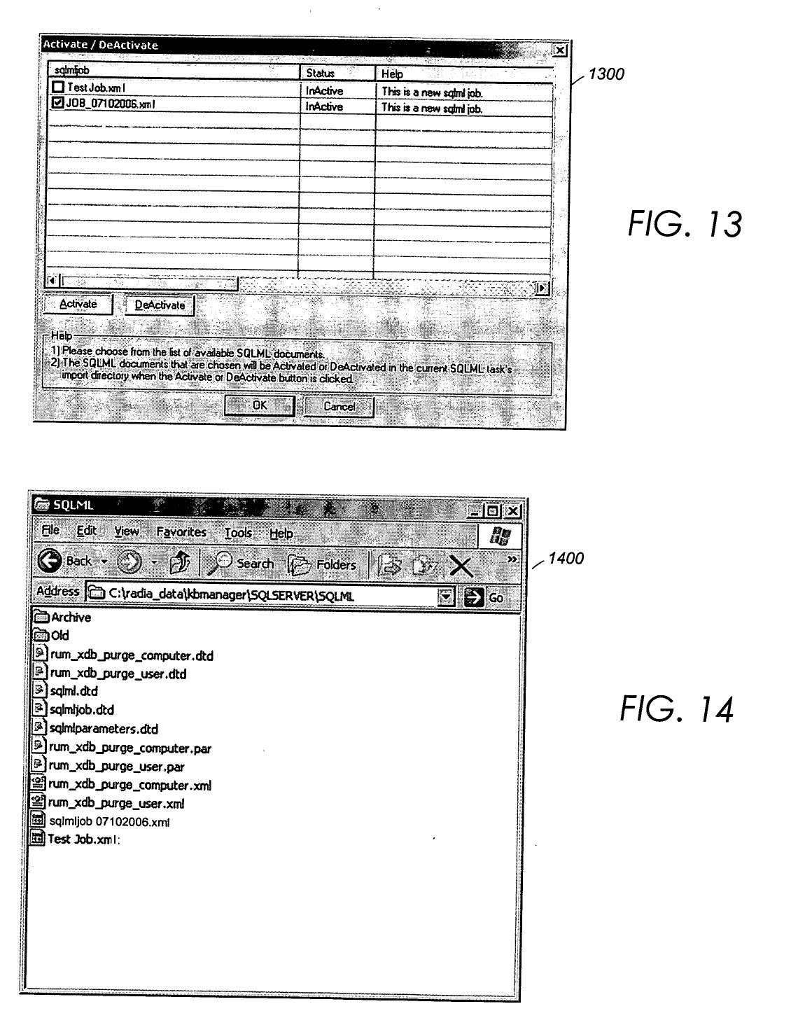

Referring to FIGS. 3 and 13, an embodiment of a form 1300 generated by process Activate Or Deactivate A Document 320 is shown that allows the user to activate or deactivate a document 104. Form 1300 also indicates whether the document is active or inactive. Documents will be activated or deactivated, according to the user's selections, in the import directory. In some embodiments, deactivating a document causes SQLML component 106 to change the name of the document, for example, to a name with a suffix indicating that the document is inactive.

Referring to FIGS. 3 and 14, an embodiment of a form 1400 generated by process View Contents Of A SQLML Import Directory 322 is shown that allows the user view the documents in an import directory. The view can indicate the pathname of the import directory as well as the names, types, size, create/modify date of the files and directories. Other suitable information can be presented on form 1400. Additionally, SQLML SQLML documents 102 and SQLMLJOB documents 104 that are created via user interface 116 or other suitable manner, can be included in the import directory. For example, the file sqlmljob_{—}07102006.xml is a SQLMLJOB document 104 that is generated via user interface 116. Note that the import directory includes an archive directory where files for jobs that have been executed can be placed. An example of a SQLMLJOB document 104 is as follows:

```
<?xml version=“1.0” ?>
<!DOCTYPE sqlmljob SYSTEM “sqlmljob.dtd”>
<sqlmljob>
    <sqlmlversion>1.0</sqlmlversion>
    <sqlmlhelp>This job purges computer and user information from
    the database</sqlmlhelp>
    <compatibility>
        <database>SQL Server</database>
        <database>Oracle</database>
    </compatibility>
    <job>
        <transaction>
        <catch>
        <document>rum_xdb_purge_computer.xml</document>
        <document>rum_xdb_purge_user.xml</document>
        </catch>
        </transaction>
    </job>
</sqlmljob>
```

Note also that information for the files in the import directory can be entered in other suitable manners such as reading from files or dynamic input during execution of process 202 (FIG. 2) in addition to or instead of entering information via forms 400-1300.

The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components are disclosed herein as separate and discrete components. These components may, however, be combined to form larger or different software modules, logic modules, integrated circuits, or electrical assemblies, if desired.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

What is claimed:

1. A computer product comprising:
a processing component configured to access a database and execute statements that reside in a document, wherein the document includes:
a tag identifying whether database processing statements in the document are to be executed; and
a tag identifying a group of the database processing statements.

2. The computer product of claim 1, wherein the document further includes:
a tag indicating whether information regarding processing errors are to be logged.

3. The computer product of claim 1, wherein the document further includes:
a tag identifying a group of tags.

4. The computer product of claim 1, wherein the document further includes:
a tag identifying a compatible database.

5. The computer product of claim 1, wherein the document further includes:
a statement indicating whether one or more files are used to process the document.

6. The computer product of claim 1, wherein the database processing statements are Structured Query Language (SQL) statements.

7. The computer product of claim 1, wherein the document is an Extensible Markup Language (XML) document.

8. The computer product of claim 1, wherein the database processing statements are Structured Query Language (SQL) statements.

9. The computer product of claim 1, wherein the processing component is configured to handle errors and exceptions that occur while executing the statements in the document.

10. The computer product of claim 1, wherein the database processing
statements are executed asynchronously.

11. The computer product of claim 1, wherein the processing component
utilizes a connection to the database.

12. The computer product of claim 1, wherein the processing component is configured to rollback changes to the database when an error occurs during processing, and to commit changes to the database if an error does not occur during processing.

13. The computer product of claim 7, further comprising:
a Document Type Definition (.dtd) file for the document, wherein the .dtd specifies elements that can be included in the document.

14. The computer product of claim 1, further comprising:
a parameter file for the document, wherein the parameter file specifies values for elements that are included in the document.

15. The computer product of claim 1, further comprising:
a user interface configured to generate interactive forms to allow the user to perform at least one of the group consisting of: generate a new document, modify and delete an existing document, enter values for parameters associated with the new or existing document, group documents together to create a job document, activate/deactivate the document, schedule execution of the document, and specify a database connection.

16. A method comprising:
generating a job document that specifies a plurality of computer readable documents, wherein the plurality of computer-readable documents specify commands to be executed on a database; and
processing the job document via a computer-implemented component, wherein the component utilizes a connection to the database, and processes the plurality of computer readable documents to execute the commands on the database.

17. The method of claim 16, wherein the component further handles errors that occur while processing the plurality of computer readable documents.

18. The method of claim 17, wherein the plurality of computer readable documents specify whether the component should handle the errors that occur.

19. The method of claim 16, further comprising:
executing the commands asynchronously.

20. The method of claim 16, wherein the plurality of computer-readable documents include at least one of the group consisting of:
a tag indicating whether information regarding processing errors are to be logged,
a tag identifying a group of tags, and
a tag identifying a compatible database.

21. The method of claim 16, wherein the commands are Structured Query Language (SQL) statements.

22. The method of claim 16, wherein the job document and the plurality of computer readable documents are Extensible Markup Language (XML) documents.

23. The method of claim 16, further comprising:
generating interactive forms on a computer display to allow the user to perform at least one of the group consisting of: generate new documents, modify and delete existing documents, enter values for parameters associated with the new or existing documents, group documents-together to create the job document, activate/deactivate the documents, schedule execution of the documents, and specify a database connection.

24. An apparatus comprising:
computer implemented means for generating a plurality of documents, wherein the documents specify procedures to be performed on a database;
computer implemented means for grouping at least some of the plurality documents to create a job document; and
computer implemented means for processing the job including establishing a connection to the database specified in the plurality of documents, and executing the procedures specified in the plurality of documents.

25. The apparatus of claim 24, wherein at least one of the plurality of
documents includes means for specifying whether information regarding errors while processing the job should be logged.

26. The apparatus of claim 24, further comprising:
means for rolling back changes to the database when an error occurs during processing, and committing changes to the database if an error does not occur during processing.

27. The apparatus of claim 24, wherein the documents are Extensible Markup Language (XML) documents and the procedures to be performed on the database are specified by Structured Query Language (SQL) statements.

28. The apparatus of claim 27, further comprising:
Document Type Definition (.dtd) files corresponding to the plurality of documents, wherein the .dtd specifies elements that can be included in the plurality of documents.

29. The apparatus of claim 24, further comprising:
user interface means for allowing the user to perform at least one of the group consisting of: generate a new document, modify and delete an existing document, enter values for parameters associated with the new or existing document, group documents together to create a job document, and activate/deactivate the document.

30. The apparatus of claim 24, further comprising:
user interface means for allowing the user to schedule execution of the job document.
